(19) United States
(12) Patent Application Publication
(10) Pub. No.: US 2003/0158012 A1
(43) Pub. Date: Aug. 21, 2003

(54) Differential assembly

(76) Inventor: Georg Kwoka, Much (DE)

Correspondence Address: Robert P. Renke, Suite 250, 28333 Telegraph Road, Southfield, MI, 48034, US

(21) Appl. No.: 10/353,472

(22) Filed: Jan. 29, 2003

(30) Foreign Application Priority Data
Jan. 29, 2002 (DE) 102 03 294.7

(51) Int. Cl. F16H 48/20; B60K 17/35

(52) U.S. Cl. 475/224; 192/218

(57) ABSTRACT

The invention relates to a differential assembly (6, 7) comprising a differential drive (13), a differential-speed-sensing locking mechanism (23) and a brake assembly (11). The differential drive comprises a housing (10) with a driving journal (18) rotatably supported therein and with a carrier (12) which, in respect of drive, is connected to the driving journal (18) and which is rotatably supported in the housing (10), and differential gears (20, 20′) which rotate with the carrier (12) and are rotatably supported therein, as well as two axle shaft gears (19, 19′) which engage the differential gears (20, 20′). The differential-speed-sensing locking mechanism (23) serves to adapt the rotational speed between the two axle shaft gears (19, 19′). The brake assembly (11) is arranged at the housing (10) and serves to brake the rotational movements of the two axle shaft gears (19, 19′) relative to the housing (10).

### TECHNICAL FIELD

The invention relates to a differential assembly. In particular, the invention relates to a driven axle of a motor vehicle, which forms part of a driveline and which compensates for different rotational movements of the wheels of one axle, such as occurs when the vehicle travels along a curved path.

### BACKGROUND OF THE INVENTION

There are prior art differential assemblies for a driven axle of a motor vehicle wherein, between the output shafts of a differential drive and the sideshafts connected thereto in respect of the drive, there are arranged disc brakes next to the differential drive. The disc brakes each comprise a brake disc firmly connected to the respective output shaft and a calliper with movable brake jaws attached to the housing of the differential drive. At each sideshaft, there is provided one brake disc which serves to brake the respective wheel drivingly connected to the sideshaft.

### SUMMARY OF THE INVENTION

The present invention provides a differential assembly having a simplified design and which, at the same time, provides good braking performance.

In particular the present invention provides a differential assembly, such as for one driven axle of a motor vehicle having a plurality of driven axles, comprising a differential drive with a housing, a driving journal supported therein, and a carrier which is drivingly engaged with the driving journal and which is rotatably supported in the housing, and differential gears which rotate together with the carrier and are rotatably supported therein, as well as two axle shaft gears engaging the differential gears. The assembly also includes a differential-speed-sensing locking mechanism to adjust the rotational speed differential between the two axle shaft gears, as well as a brake assembly which is arranged at the housing for braking the rotational movement of the carrier relative to the housing.

The present differential assembly is advantageous in that only one single brake assembly is required for braking both axle shaft gears. In this way, it is possible to reduce the number of parts, to save weight and to decrease production costs. The differential-speed-sensing locking mechanism ensures that the process of braking the carrier affects both axle shaft gears in that a relative deviation of the rotational speed between the axle shaft gears causes the locking mechanism to engage, thus enforcing a speed adjustment, i.e. a speed differential reduction.

According to one embodiment of the invention, the brake assembly is arranged inside the housing. This is advantageous in that, in the housing, the brake assembly is protected from external influences. It is thus possible to prevent dirt from entering the brake assembly. This may reduce wear and may prolong the braking performance. According to an alternative embodiment, the brake assembly is arranged outside the housing and acts on the driving journal. The advantage of this arrangement is that it simplifies the design and facilitates easier maintenance work on the brake assembly.

The locking mechanism which is controlled as a function of the differential speed ensures that any speed differential between the driveshafts is compensated for both at acceleration and braking of the vehicle. Such a speed differential can occur, for example, as a result of different friction conditions at the wheels relative to the ground. In this way, it is ensured that a braking torque generated by the brake assembly, if the two wheels of one axle rotate at different speeds, is transferred to that particular wheel which features a better adhesion value relative to the road surface. The locking mechanism of the differential assembly can be provided in the form of a Visco-Lok® coupling, with the locking effect being generated as a function of the different rotational speeds of the sideshafts by means of a viscous medium. According to an alternative embodiment, the locking mechanism can be provided in the form of a viscous coupling. In both embodiments, the locking mechanism is preferably effective between the carrier and one of the axle shaft gears. Alternatively, they can be effectively arranged between the two axle shaft gears.

According to another embodiment of the invention, the brake assembly comprises rotating parts which, in a first embodiment, are secured to the driving journal or, according to a second embodiment, to the carrier, and comprise fixed parts which are attached to the housing. This is advantageous in that the brake assembly generates a braking force which acts on both axle shaft gears, so that only one brake assembly is required for one axle. In a further embodiment of the invention, the rotating parts of the brake assembly are provided in the form of a brake disc and the fixed part of the brake assembly is in the form of a calliper which comprises movable jaws blocks. However, other types of brake assemblies are also contemplated, such as for example, a drum brake or band brake which are effective between the housing and the driving journal or the carrier.

In the case of the embodiment wherein the brake assembly acts on the driving journal, the brake disc is positioned coaxially on the driving journal and the calliper is connected to the housing.

In a first variant of the embodiment with a brake assembly acting on the carrier, there is provided a ring gear which is drivingly engaged with the driving journal, wherein the rotating parts of the brake assembly are fixed to the carrier in a region adjoining the ring gear. In this way, it is possible to use common connecting means between the carrier, ring gear and brake disc.

According to a second variant, the carrier comprises a ring gear which is drivingly engaged with the driving journal, and the rotating parts of the brake assembly and the ring gear are secured to the carrier on different sides of the central plane which is positioned so as to be axis-normal and extending substantially symmetrically relative to the axle shaft gears. This embodiment is advantageous in that the brake assembly on the one hand and the ring gear on the other hand are arranged at the carrier in a way which ensures an advantageous distribution of masses.

Both the above-mentioned embodiments, i.e. the one having a brake disc attached to the driving journal and the one having a brake disc attached to the carrier, ensure that the braking forces generated by the brake, in the direction of the torque flow, act on the respective components before the torque is distributed to the two sideshafts. As a result, only one brake is required in both cases for delaying the two axle shafts.

In another example, the present invention provides a motor vehicle with a drive source, at least a first driven axle and at least one differential assembly which is part of a driveline for driving the driven axle. The differential assembly includes a differential drive with a housing, a driving journal supported therein, and a carrier which is drivingly engaged with the driving journal and which is rotatably supported in the housing, and differential gears which rotate together with the carrier and are rotatably supported therein, as well as two axle shaft gears which engage the differential gears. The assembly also includes a differential-speed-sensing locking mechanism to adjust the rotational speed differential between the two axle shaft gears, as well as a brake assembly which is arranged at the housing for braking the rotational movement of the carrier relative to the housing.

The driving journal can be connected to the drive source and the axle shaft gears to the sideshafts of the first driven axle. The differential assembly can be provided in the form of any of the embodiments as mentioned above. The advantage of the above-mentioned vehicle is that the driven axle requires only one single brake assembly which, in the direction of the flow of force, acts on the driving journal or on the carrier before the force is distributed to the sideshafts. As a result, it is possible to reduce the number of parts and to save weight.

According to a further embodiment of the invention, the motor vehicle, furthermore, comprises a second driven axle and a second differential assembly which forms part of a second driveline for driving the second axle. The differential assembly can also be provided in the form of any one of the above-mentioned embodiments.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiment illustrated in greater detail in the accompanying drawings and described below by way of examples of the invention.

In the drawings:

FIG. 1 is a diagrammatic illustration of the drive of a motor vehicle having differential assemblies in accordance with the invention.

FIG. 2 shows a first embodiment of an inventive differential assembly in a longitudinal half-section.

FIG. 3 shows a second embodiment of an inventive differential assembly in a longitudinal half-section.

FIG. 4 shows a third embodiment of an inventive differential assembly in a longitudinal half-section.

### DETAILED DESCRIPTION OF THE INVENTION

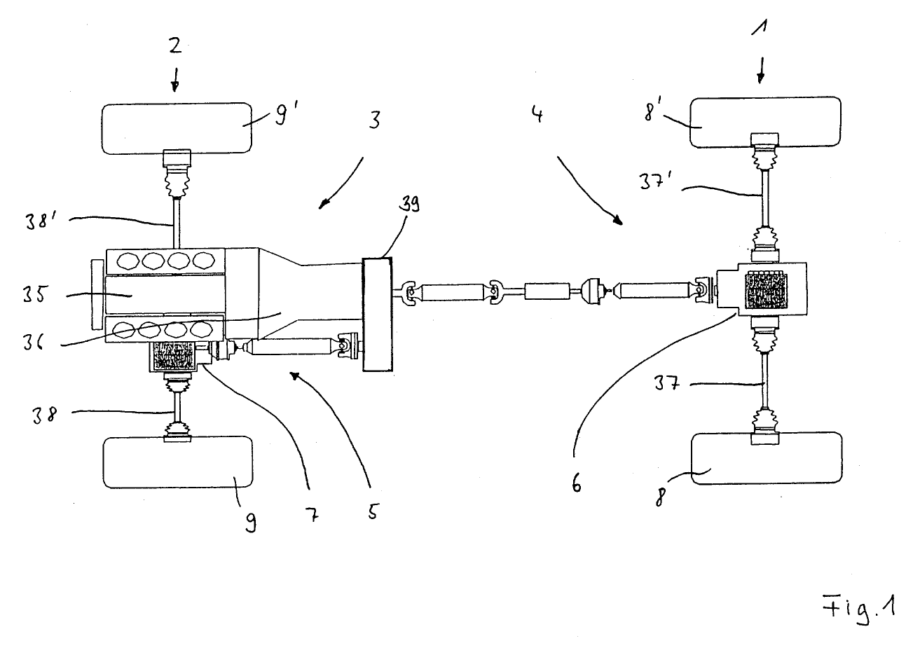

FIG. 1 is a diagram of a drive-line of a four-wheel drive motor vehicle with a first (rear) axle 1 and a second (front) axle 2. A drive source 3 comprising an engine 35 with a manual gearbox 36 and a distributor box 39, via a first multi-member driveline 4, drives the first axle 1 and, via a second driveline 5, drives the second axle 2. The two drivelines 4, 5 are constantly connected to the drive source 3. Of course, the drive source 3 can comprise other vehicle power plants such as an internal combustion engine, electric motor, hybrid-electric motor or fuel cell-based engine, for example.

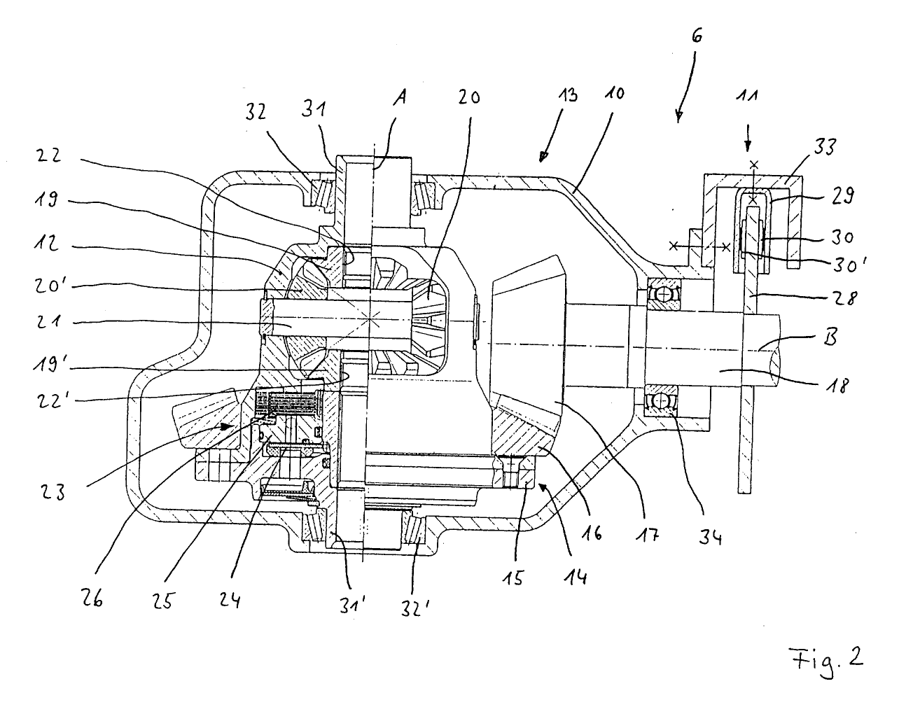

To be able to compensate for the different rotational speed which occurs in curves or in the case of wheel slip between the two wheels of one axle, each axle is provided with a differential assembly one of which, representing the two, is described in greater detail in each of FIGS. 2 to 4. The first driveline 4 comprises a first differential assembly 6 for compensating for the different rotational speed of the rear wheels 8, 8′, and the second driveline 5 is provided with a second differential assembly 7 for compensating for different rotational speed of the front wheels 9, 9′. The rear wheels 8, 8′, in respect of drive, are connected via two rear sideshafts 37, 37′ to the first differential assembly 6, and the front wheels 9, 9′, via two front sideshafts 38, 38′, are connected to the second differential assembly 7.

FIG. 2 shows a first embodiment of such a differential assembly 6. It comprises a differential drive 13 with a housing 10 and a carrier 12 arranged in the housing 10, as well as a brake 11 attached to the outside of the housing 10. The carrier 12 is provided with two projections 31, 31′ by means of which it is rotatably supported in the housing 10 via two bearings 32, 32′ around an axis A. The carrier 12 is cup-shaped and, on one side, comprises a flange 14 to which there is attached a cover 15. Furthermore, the flange 14 is connected to a ring gear 16 which serves to rotatingly drive the carrier 12 around its axis A. The ring gear 16 is rotatingly driven by a bevel gear 17 which is connected to a driving journal 18 of the differential assembly 6. The driving journal 18 is rotatably supported on an axis B in the housing 10 by means of a rolling contact bearing 34, with the axis B being positioned perpendicularly on the axis A.

In the carrier 12, two coaxially arranged axle shaft gears 19, 19′ engaging the differential gears 20, 20′ are rotatably arranged on the axis A. The differential gears 20, 20′ are rotatably arranged on a shaft 21 perpendicular to the axis A. The axle shaft gears 19, 19′ each comprise a bore with inner toothings 22, 22′ which serve to connect, in a rotationally fast way, two sideshafts (not shown in greater detail) for driving the wheels. Furthermore, the carrier 12 contains a differential-speed-sensing locking mechanism 23. In this example, the differential-speed-sensing locking mechanism 23 is a viscous shear pump assembly such as a ViscoLok® coupling which comprises a shear pump 24, a piston 25 and a friction plate assembly 26 and which acts between the carrier 12 and one of the axle shaft gears 19, 19′. If there exists a speed differential between the axle shaft gears 19, 19′, the shear pump 24, by means of a viscous fluid, generates a pressure force which increases with the speed differential and which, via the piston 25, loads the friction plate coupling 26. In this way, in case one of the axle shaft gears 19, 19′ rotates faster than the other, the slower or stationary axle shaft gear is braked and driven as a result of the torque build-up taking place in the Visco-Lok® coupling 23. The differential-speed-sensing locking mechanism 23 could also be a viscous coupling.

The brake 11 which forms part of the differential assembly 6 comprises a brake disc 28 and a calliper 29 with brake jaws 30, 30′. The brake disc 28 is firmly connected to the driving journal 18 of the differential assembly 6. The calliper 29 is secured by a carrier 33 to the housing 10. When the brake 11 is actuated, the brake jaws 30, 30′ are pressed against the brake disc 28 from both sides, as a result of which there is generated a braking moment at the driving journal 18 which is transmitted via the carrier 12 to the sideshafts and finally to the wheels. Other types of brake assemblies are also contemplated including a drum brake or band brake which are effective between the housing 12 and the driving journal 18 or the carrier 12.

The advantage of such a differential assembly 6 with a connected brake 11 is that it requires only one brake for delaying both axle shaft gears 19, 19′ and thus both sideshafts. According to a variant of the differential assembly according to FIG. 2, the brake can also be arranged inside the housing 10. In the housing 10, there is provided lubricant (not shown in greater detail) for lubricating and cooling the movable parts when the differential assembly 6 is in operation. To ensure that the disc brake functions properly when it is located within the housing 10 with lubricant, the brake linings are wet brake linings which, even in the lubricant bath, build up a sufficiently high friction force relative to the brake disc in order to generate the full braking moment.

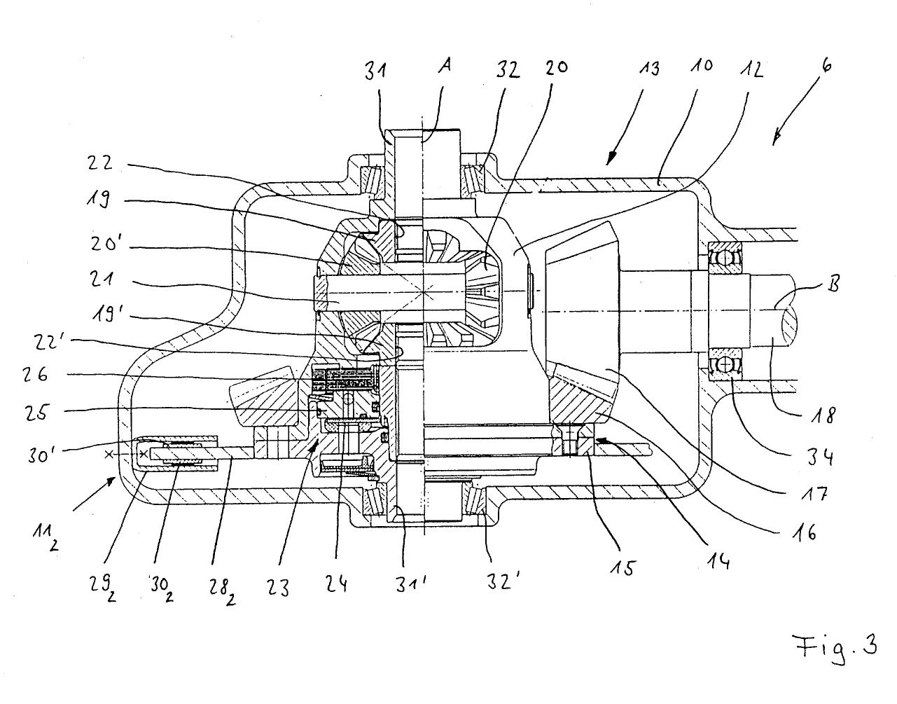

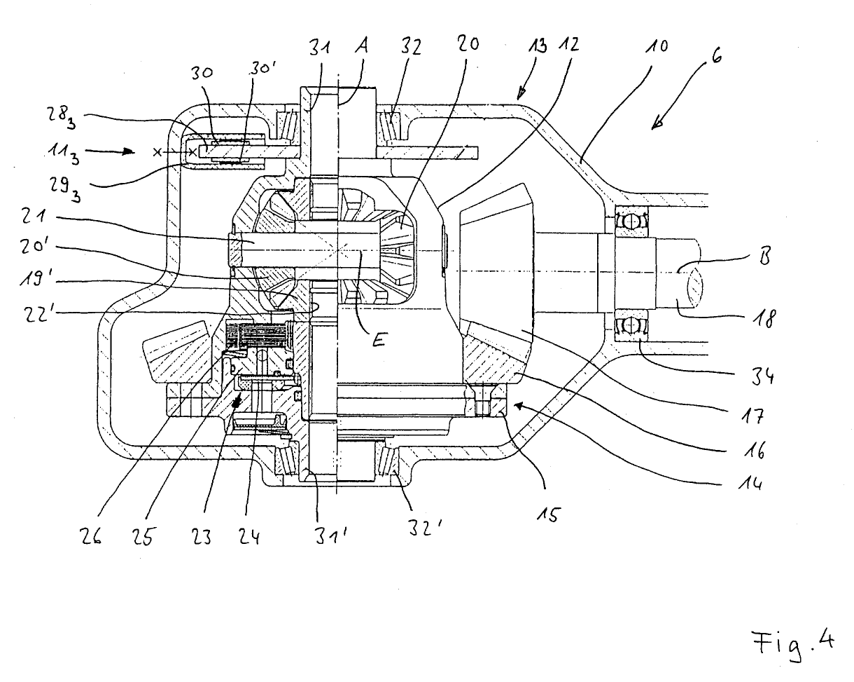

FIGS. 3 and 4 show a second and third embodiment of the differential assembly 6. In respect of design, these variants substantially correspond to the differential assembly according to FIG. 2. Thus, identical components have been given the same reference numbers and any components which are arranged differently from those shown in FIG. 2 have been reference numbers provided with the indices 2 and 3.

The differential assemblies 6 according to FIGS. 3 and 4 comprise disc brakes 11₂, 11₃ which act directly on the carrier 12. The disc brakes 11₂, 11₃ each comprise a brake disc 28₂, 28₃ which is firmly connected to the carrier 12, as well as a calliper 29₂, 29₃ provided with two brake jaws 30₂, 30_{2′}; 30₃, 30_{3′} which are firmly connected to the housing 10. The brake linings of the brake jaws 30₂, 30_{2′}; 30₃, 30_{3′} are provided in the form of wet brake linings which, even in the lubricant bath of the differential assembly 6, build up a sufficiently high friction force relative to the brake disc for generating the full braking torque. In the variant according to FIG. 3, the disc brake 11₂ is arranged so as to adjoin the ring gear 16 and is attached to the cover 15 by means of common fixing means.

In the variant according to FIG. 4, the disc brake 11₃ is secured to the side of the carrier 12 opposing the ring gear 16. The disc brakes 11₃ on the one hand and the ring gear 16 on the other hand are connected to the carrier 12 on different sides of a central plane E which, in an axis-normal way, is positioned approximately symmetrically relative to the differential gears 20, 20′.

According to another embodiment, the disc brake can be secured to the outside of the housing and act on one of the two projections of the carrier. This embodiment would be advantageous in that it would be more maintenance-friendly.

While the invention has been described in connection with one or more embodiments, it should be understood that the invention is not limited to those embodiments. Thus, the invention covers all alternatives, modifications, and equivalents as may be included in the spirit and scope of the appended claims.

What is claimed is:

1. A differential assembly (6, 7) comprising:
a differential drive (13) with a housing (10);
a driving journal (18) supported in the housing (10);
a carrier (12) which is drivingly engaged with the driving journal and which is rotatably supported in the housing;
differential gears (20, 20′) which rotate together with the carrier (12) and are rotatably supported in the carrier (12);
two axle shaft gears (19, 19′) engaging the differential gears (20, 20′);
a differential-speed-sensing locking mechanism (23) for adjusting a rotational speed differential between the two axle shaft gears (19, 19′); and
a brake assembly (11) which is arranged at the housing (10) and which serves to brake the rotational movement of the carrier (12) relative to the housing (10).

2. A differential assembly according to claim 1, wherein the brake assembly (11) is arranged outside the housing (10) and acts on the driving journal (18) or on a projection (31, 31′) of the carrier.

3. A differential assembly according to claim 1, wherein the brake assembly (11₂, 11₃) is arranged inside the housing (10) and acts on the driving journal (18) or directly on the carrier (12).

4. A differential assembly according to claim 1, wherein the brake assembly (11) comprises a rotating part (28) secured to the driving journal (18) or to the carrier (12), and a fixed part (29) attached to the housing (10).

5. A differential assembly according to claim 2, wherein the brake assembly (11) comprises a rotating part (28) secured to the driving journal (18) or to the carrier (12), and a fixed part (29) attached to the housing (10).

6. A differential assembly according to claim 3, wherein the brake assembly (11) comprises a rotating part (28) secured to the driving journal (18) or to the carrier (12), and a fixed part (29) attached to the housing (10).

7. A differential assembly according to claim 4, wherein the rotating part (28) of the brake assembly (11) comprises a brake disk and the fixed part (29) of the brake assembly (11) comprises a calliper which holds movable brake jaws (30, 30′).

8. A differential assembly according to claim 7, wherein the brake disc is positioned co-axially on the driving journal (18) and the calliper is connected to the housing (10).

9. A differential assembly according to claim 4, wherein the carrier (12) comprises a ring gear (16) which is drivingly engaged with the driving journal (18) and the rotating part (28) of the brake assembly (11) is secured next to the ring gear (16) at the carrier (12).

10. A differential assembly according to claim 7, wherein the carrier (12) comprises a ring gear (16) which is drivingly engaged with the driving journal (18) and the rotating part (28) of the brake assembly (11) is secured next to the ring gear (16) at the carrier (12).

11. A differential assembly according to claim 4, wherein the carrier (12) comprises a ring gear (16) which is drivingly engaged with the driving journal (18), and the rotating part (28) of the brake assembly (11) and the ring gear (16) are secured to the carrier (12) on different sides of a central plane (E).

12. A differential assembly according to claim 7, wherein the carrier (12) comprises a ring gear (16) which is drivingly engaged with the driving journal (18), and the rotating part (28) of the brake assembly (11) and the ring gear (16) are secured to the carrier (12) on different sides of a central plane (E).

13. A differential assembly according to claim 1, wherein the differential-speed-sensing locking mechanism (23) provides a locking effect as a function of the different rotational speeds of the two axle shaft gears (19, 19′) by way of a viscous medium.

14. A differential assembly according to claim 13, wherein the differential-speed-sensing locking mechanism (23) comprises a shear pump (24), a piston (25) and a friction plate assembly (26), and acts between the carrier (12) and one of the axle shaft gears (19, 19′).

15. A differential assembly according to claim 1, wherein the differential-speed-sensing locking mechanism (23) is a viscous coupling.

16. A differential assembly according to claim 1, wherein the differential-speed-sensing locking mechanism (23) is effective between the carrier (12) and one of the axle shaft gears (19, 19′).

17. A differential assembly according to claim 13, wherein 5 the differential-speed-sensing locking mechanism (23) is effective between the carrier (12) and one of the axle shaft gears (19, 19′).

18. A differential assembly according to claim 15, wherein the differential-speed-sensing locking mechanism (23) is effective between the carrier (12) and one of the axle shaft gears (19, 19′).

19. A differential assembly according to claim 1, wherein the brake assembly (11) comprises a disc brake, a drum brake or a band brake.

20. A motor vehicle having a drive source (3) at least a first driven axle (1), and at least one differential assembly (6) according to claim 1, wherein the driving journal (18) of the at least one differential assembly (6) is connected to the drive source (3) and the axle shaft gears (19, 19′) of said differential (6) are connected to sideshafts of the first driven axle (1).

21. A motor vehicle according to claim 20 having a second driven axle (2) and a second differential assembly (7) according to claim 1, wherein the driving journal of the second differential assembly (7) is connected to the drive source (3) and the axle shaft gears of said differential (7) are connected to sideshafts of the second driven axle (2).

22. A motor vehicle according to claim 21, wherein the two driving journals (18) are each constantly connected to an output shaft of the drive source (3).
